(19) United States
(12) Patent Application Publication
(10) Pub. No.: US 2006/0055817 A1
(43) Pub. Date: Mar. 16, 2006

(54) Surveillance camera

(75) Inventor: Tomokazu Ito, Toyoake (JP)

Correspondence Address: KODA & ANDROLIA, 2029 CENTURY PARK EAST, SUITE 1140, LOS ANGELES, CA, 90067, US

(73) Assignee: Elmo Co., Ltd.

(21) Appl. No.: 11/140,110

(22) Filed: May 27, 2005

(30) Foreign Application Priority Data
Sep. 15, 2004 (JP) 2004-268361

(51) Int. Cl. H04N 5/235

(52) U.S. Cl. 348/362

(57) ABSTRACT

A surveillance camera includes a lens aperture control unit controlling an amount of aperture of a lens so that a predetermined quality of image displayed on a monitor is maintained in taking an image of an object, an auto gain control unit which controls an image pickup sensitivity, a filter attachment/detachment control unit which attaches and detaches a color filter for a predetermined wavelength, a charging time control unit which controls a charging time in charging an image pickup device with electric charge, all the control units being sequentially operated, and an operation sequence setting unit which sets an operation sequence of the control units according to a type of the object.

### BACKGROUND OF THE INVENTION

1. Field of the Invention

This invention relates to surveillance cameras.

2. Description of the Related Art

In order to maintain a predetermined quality of an image obtained from an object with a low illuminance, conventional surveillance cameras have functions of changing an aperture of an image pickup lens, changing sensitivity (auto gain control function), attaching/detaching a color filter for a predetermined wavelength, and changing an accumulation time necessary for charging an image pickup device. The surveillance cameras are designed to execute the aforesaid functions in the above-described fixed sequence.

However, a priority would be given to one or more of the foregoing functions depending upon a type of an object to be surveiled and illuminance of the object, so that a predetermined quality of image displayed on a monitor can be maintained. For example, consider a case where movement, color or small amount of noise of an image to be surveiled should be taken more seriously. The effect of surveillance is considered to be improved when a function to which a higher priority is given in accordance with the illuminance of an object can be set with an execution order of the function.

### SUMMARY OF THE INVENTION

Therefore, an object of the present invention is to provide a surveillance camera in which one or more of the functions thereof to which an execution priority is given and an execution order can be set, whereupon the effect of surveillance can be improved.

In one embodiment, the present invention provides a surveillance camera comprising, a lens aperture control unit which controls an aperture of a lens so that a predetermined quality of image displayed on a monitor is maintained in taking an image of an object, an auto gain control unit which controls an image pickup sensitivity, a filter attachment/detachment control unit which attaches and detaches a color filter for a predetermined wavelength, a charging time control unit which controls a charging time in charging an image pickup device with electric charge, all the control units being sequentially operated, and an operation sequence setting unit which sets an operation sequence of the control units according to a type of the object.

The operation sequence setting unit sets the operation sequence of the lens aperture control unit, the auto gain control unit, the filter attachment/detachment control unit, and the charging time control unit. Consequently, the surveillance camera can improve the effect of surveillance.

In another embodiment, the above-described surveillance camera further comprises a threshold setting unit which is capable of setting a threshold for an amount of control executed by the each control unit.

Since the threshold setting unit is capable of setting a threshold for an amount of control executed by each control unit, a predetermined quality of image displayed on the monitor can be maintained.

### BRIEF DESCRIPTION OF THE DRAWINGS

Other objects, features and advantages of the present invention will become clear upon reviewing the following description of the embodiment with reference to the accompanying drawings, in which:

FIG. 1 is a schematic block diagram showing an arrangement of a surveillance camera of one embodiment in accordance with the invention;

FIGS. 2A and 2B are flowcharts showing a lens aperture control process;

FIGS. 3A and 3B are flowcharts showing an AGC process;

FIGS. 4A and 4B are flowcharts showing a CCD charging time control process; and

FIGS. 5A and 5B are schematic flowcharts showing a high-sensitivity process.

### DETAILED DESCRIPTION OF THE INVENTION

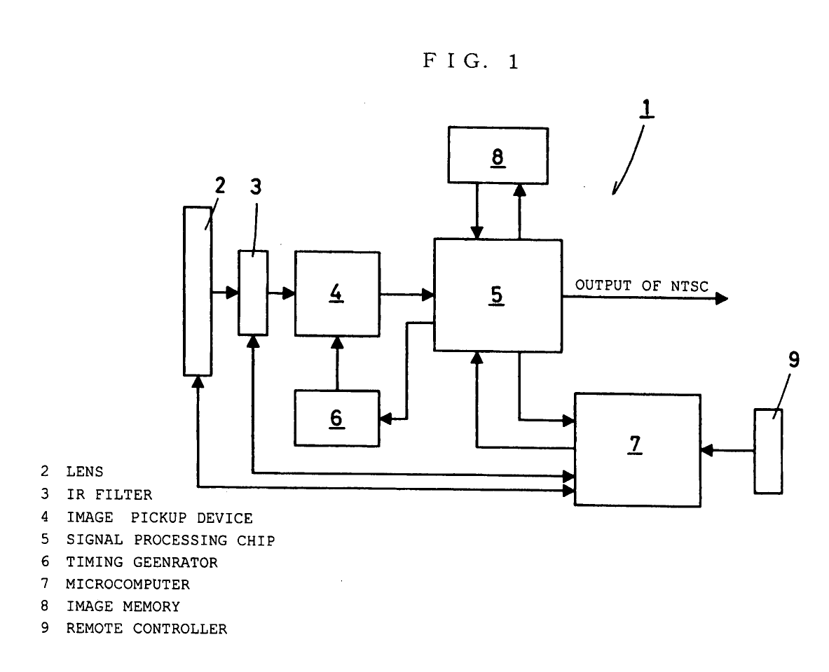

One embodiment of the present invention will be described with reference to the accompanying drawings. Referring to FIG. 1, a surveillance camera 1 includes a lens 2 with a lens aperture control mechanism 2, an infrared (IR) filter 3, an image pickup device (charge coupled device (CCD)) 4, a signal processing chip 5, a timing generator 6, a microcomputer 7 and an image memory 8. The surveillance camera 1 is further provided with a setting remote controller 9.

The microcomputer 7 executes a control program installed thereon to carry out a lens aperture control which controls an amount of stop of a lens, an auto gain control (AGC) which controls an image-taking sensitivity, a filter attachment/detachment control which attaches and detaches a color filter for a predetermined wavelength, and a charging time control (CCD charging time control) which controls a charging time in charging an image pickup device with electric charge.

For this purpose, the microcomputer 7 obtains information about lens aperture from the lens 2 and generates an aperture control signal. Furthermore, the microcomputer 7 supplies an attachment/detachment signal to the IR filter 3. An image signal is supplied from the image pickup device 4 to the signal processing chip 5, which then supplies information about brightness to the microcomputer 7. The microcomputer 7 supplies a predetermined control signal to the signal processing chip 5, which then supplies a timing signal to the timing signal generator 6. The timing signal generator 6 carries out for the image pickup device 4 on the basis of the timing signal.

Furthermore, an image signal is supplied from the image pickup device 4 to the signal processing chip 5, which stores the image signal on the image memory 8. The signal processing chip 5 further reads out the image signal to convert the signal to a composite video signal such as National Television System Committee (NTSC). The composite video signal is supplied to a monitor (not shown) so that an image is displayed. The remote controller 9 is operated to supply various control signals and set signals to the microcomputer 7.

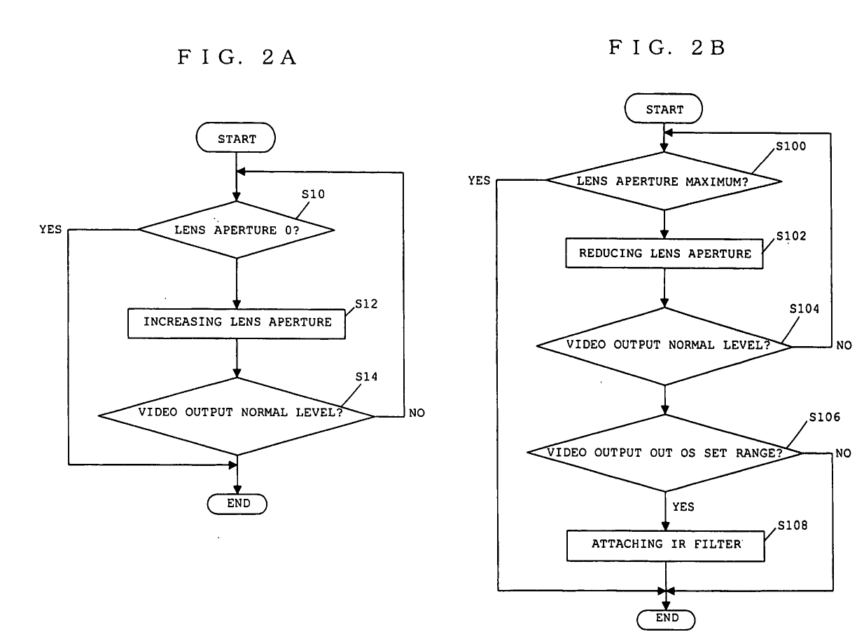

FIGS. 2A and 2B are flowcharts showing the lens aperture control process executed by the microcomputer 7. FIG. 2A shows a lens aperture control process in a case where a brightness level of the surveillance camera drops such that an image is darkened. Upon start of the process, the microcomputer 7 determines at step S10 whether the lens aperture has reached 0 (open state). When determining in the affirmative, the microcomputer 7 finishes the process. When determining in the negative, the microcomputer 7 advances to step S12 to further increase the lens aperture (dropping control voltage). The microcomputer 7 further advances to step S14 determines whether a video output level (the level of an image signal supplied from the image pickup device 4) is a normal level (100 IRE (0.714 Vp-p). When determining in the negative, the microcomputer 7 returns to step S10 to continue the lens aperture control. When determining in the affirmative, the microcomputer 7 finishes the process.

FIG. 2B shows a lens aperture control process in a case where a brightness level of the surveillance camera rises such that an image is brightened, together with the subsequent filter attachment/detachment process. Upon start of the process, the microcomputer 7 determines at step S100 whether the lens aperture has become a maximum at the stop side (closed state). When determining in the affirmative, the microcomputer 7 finishes the process. When determining in the negative, the microcomputer 7 advances to step S102 to further reduce the lens aperture (increasing the control voltage). The microcomputer 7 further advances to step S104 to determine whether the video output has reached a normal level. When determining in the negative, the microcomputer 7 returns to step S100 to continue the lens aperture control. When determining in the affirmative, the microcomputer 7 advances to step S106 to determine whether the lens aperture value is out of a set range.

In setting a range of lens aperture value, the open side is set to one of lens aperture or stop numbers, 240, 192, 160, 144, 128 and 112 out of closed state (0) to open state (255). In the case of negative determination at step S106, the image signal is at a normal level and moreover, the lens aperture value is within the set range. Accordingly, the microcomputer 7 finishes the process. In the case of affirmative determination at step S106, the image signal is at a normal level and moreover, the lens aperture value is out of the set range. Accordingly, following the lens aperture control, the microcomputer 7 executes a filter attachment/detachment control at step S108. In this case, the IR filter 3 is attached to the camera 1 and the process is finished.

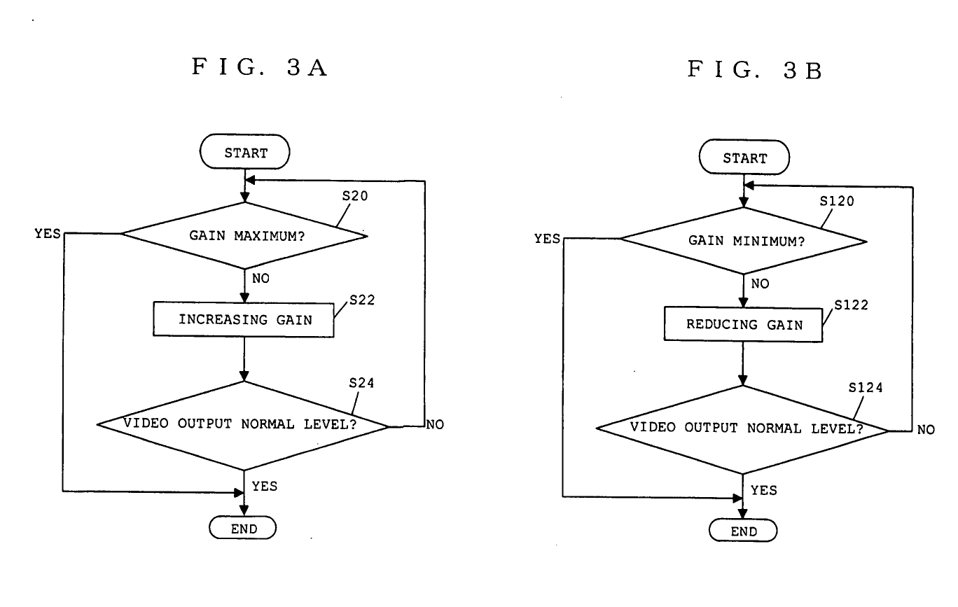

FIGS. 3A and 3B are flowcharts showing an auto gain control (AGC) process. FIG. 3A shows an AGC process in the case where the brightness level of the surveillance camera 1 drops such that an image is darkened. Upon start of the process, the microcomputer 7 determines at step S20 whether gain has become maximum as the result of AGC process. One of 4, 8, 12, 16, 20 and 24 dB is selectively settable. When determining in the affirmative, the microcomputer 7 finishes the AGC process. When determining in the negative, the microcomputer 7 advances to step S22 to raise the control voltage of the AGC process thereby to reduce the gain. The microcomputer 7 then advances to step S24 to determine whether the video output has reached a standard level. When determining in the negative, the microcomputer 7 returns to step S20 to continue the AGC process. When determining in the affirmative, the microcomputer 7 finishes the process.

FIG. 3B shows an AGC process in the case where the brightness level of the surveillance camera 1 rises such that an image is brightened. Upon start of the process, the microcomputer 7 determines at step S120 whether gain has become minimum or at 0 dB as the result of AGC process. When determining in the affirmative, the microcomputer 7 finishes the AGC process. When determining in the negative, the microcomputer 7 advances to step S122 to drop the control voltage of the AGC process thereby to reduce the gain. The microcomputer 7 then advances to step S124 to determine whether the image signal supplied from the image pickup device 4 has reached a normal level. When determining in the negative, the microcomputer 7 returns to step S120 to continue the AGC process. When determining in the affirmative, the microcomputer 7 finishes the process.

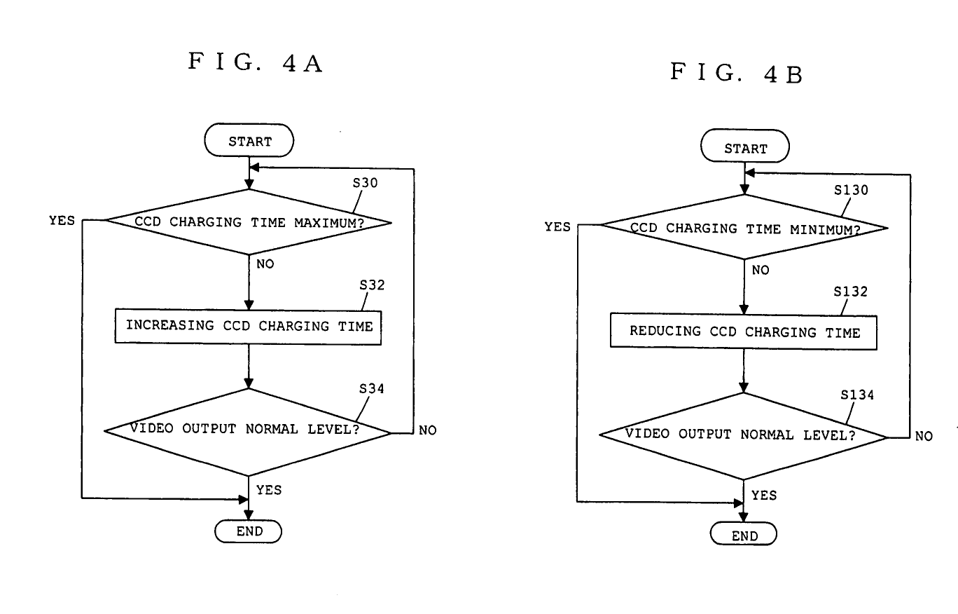

FIGS. 4A and 4B are flowcharts showing a CCD charging time control process. FIG. 4A shows a CCD charging time control process in the case where the brightness level of the surveillance camera 1 drops such that an image is darkened. Upon start of the process, the microcomputer 7 determines at step S30 whether a CCD charging time has reached a maximum value. The maximum value can be set selectively in a range from 2 to 80 field. When determining in the affirmative, the microcomputer 7 finishes the process. When determining in the negative, the microcomputer 7 advances to step S32 to increase the CCD charging time so that the lightness of displayed image is increased. The microcomputer 7 then advances to step S34 to determine whether the video output has reached a normal level. When determining in the negative, the microcomputer 7 returns to step S30 to continue the CCD charging time control. When determining in the affirmative, the microcomputer 7 finishes the process.

FIG. 4B shows a CCD charging time control process in the case where the brightness level of the surveillance camera 1 rises such that an image is brightened. Upon start of the process, the microcomputer 7 determines at step S130 whether the CCD charging time has become minimum or 1/60 sec. When determining in the affirmative, the microcomputer 7 finishes the CCD charging time control process. When determining in the negative, the microcomputer 7 advances to step S132 to reduce the CCD charging time so that the lightness of displayed image is reduced. The microcomputer 7 then advances to step S134 to determine whether the image signal supplied from the image pickup device 4 has reached a normal level. When determining in the negative, the microcomputer 7 returns to step S130 to continue the CCD charging time control process. When determining in the affirmative, the microcomputer 7 finishes the process.

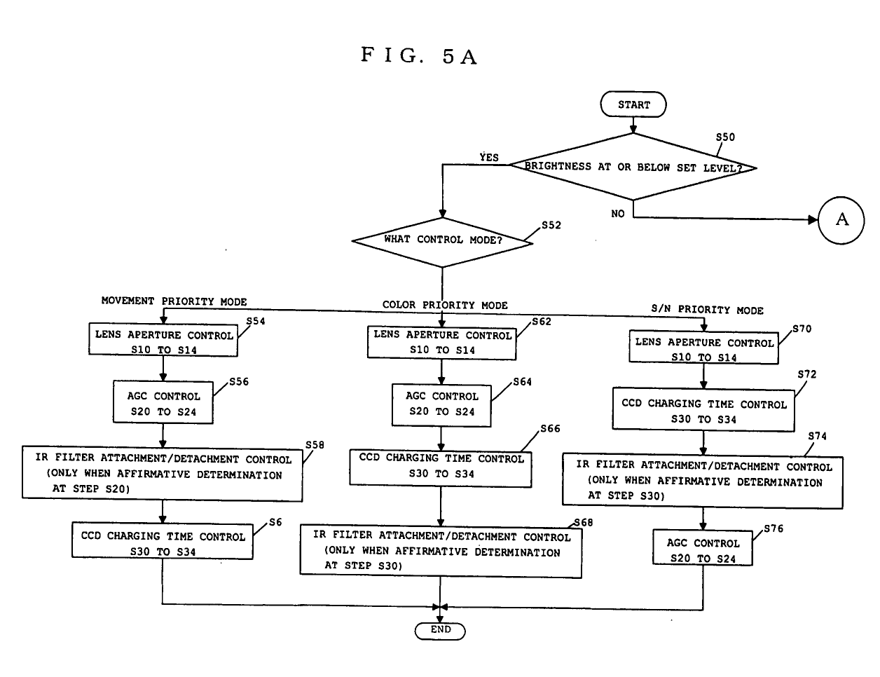

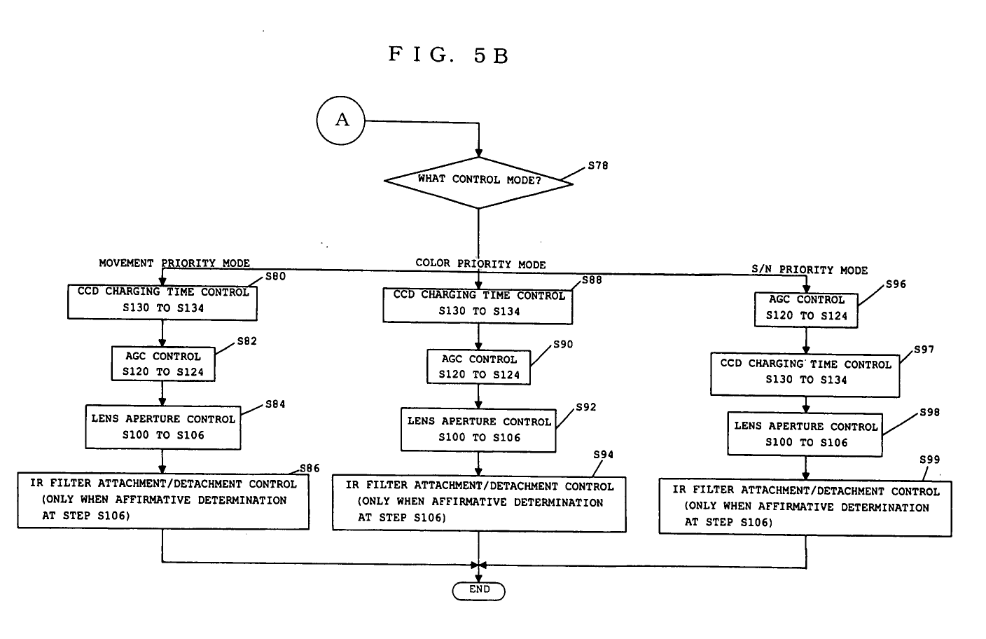

In the above-described surveillance camera 1, each control process to which priority is given and an execution order of each control process are set according to the illuminance field in a case where the movement of image of a surveillance object is taken seriously, a case where the color of image of the object to be surveiled is taken seriously, and a case where a small amount of noise is taken seriously, whereby a high-sensitivity process is carried out. FIGS. 5A and 5B are flowcharts showing an outline of the high-sensitivity process.

Upon start of the process, the microcomputer 7 at step S50 whether the brightness of the surveillance camera is at or below the set level of 100 IRE. When determining in the affirmative, the microcomputer 7 selects one of control modes at step S52. The control modes include a movement priority mode in which the movement of an image of the object to be surveiled is taken seriously, a color priority mode in which the color of an image of the object to be surveiled is taken seriously, and an S/N priority mode in which smallness in an amount of noise in an image of the object to be surveiled is taken seriously.

In a control routine of the movement priority mode in which the brightness of the surveillance camera is at or below the set level, the microcomputer 7 sets a sequence of the lens aperture control at step S54 (steps S10 to S14), the AGC control at step S56 (steps S20 to S24), the filter attachment/detachment control in which the IR filter 3 is detached when the microcomputer has determined that the gain has become maximum as the result of the AGC control at step S58 (determination in the affirmative at step S20), and the CCD charging time control at step S60 (steps S30 to 34). The surveillance camera is then controlled in the basis of the set control sequence. In a control routine of the color priority mode, the microcomputer 7 sets a sequence of the lens aperture control at step S62, the AGC control at step S64, the CCD charging time control at step S66, and a filter attachment/detachment control in which the IR filter 3 is detached when the microcomputer determines that the CCD charging time has become maximum, as the result of the CCD charging time control at step S68 (affirmative determination at step S30).

In a control routine of the S/N priority mode, the microcomputer 7 sets a sequence of the lens aperture control at step S70, the CCD charging time control at step S72, the filter attachment/detachment control in which the IR filter 3 is detached when the microcomputer 7 has determined that the CCD charging time has become maximum, as the result of the CCD charging time control at step S74 (affirmative determination at step S30).

The microcomputer 7 selects one of control modes at step S78 when determining in the negative at step S50 (when the brightness of the surveillance camera has exceeded the set level of 100 IRE). As at step S52, the control modes include a movement priority mode in which the movement of an image of the object to be surveiled is taken seriously, a color priority mode in which the color of an image of the object to be surveiled is taken seriously, and an S/N priority mode in which smallness in an amount of noise in an image of the object to be surveiled is taken seriously.

The following describes a control routine of the movement priority mode in the case where the brightness of the surveillance camera has exceeded a set level. The microcomputer 7 sets and controls the CCD charging time control to be executed at step S80 (steps S130 to S134), the AGC control to be executed at step S82 (steps S120 to S124) and the lens aperture control to be executed at step S84 (steps S100 to S106) and the filter attachment/detachment control in which the IR filter 3 is attached when the lens aperture is out of a set range in the lens aperture control at step S86 (the affirmative determination at step S106), sequentially in this order. A control routine of the color priority mode (steps S88 to S94) is the same as the above-described control routine of the movement priority mode.

Furthermore, in a control routine of the S/N priority mode, the microcomputer 7 sets and controls the AGC control to be executed at step S96 and the filter attachment/detachment control in which the IR filter 3 is attached when the lens aperture is out of a set range in the lens aperture control at step S99 (the affirmative determination at step S106), sequentially in this order.

Each priority mode can be set by supplying a set signal to the microcomputer 7 using the remote controller 9. The remote controller 9 is also used when a lens aperture range is set, when a maximum of gain by the AGC control is set and when a maximum of CCD charging time is set.

As described above, the surveillance camera can set the execution order of the lens aperture control, the AGC control, the filter attachment/detachment control, and the CCD charging time control according to the illuminance of an object to be surveiled. Accordingly, the sequence of these controls can be set so that execution priority is given to each of the movement priority mode, color priority mode and S/N priority mode, whereupon the effect of surveillance can be improved.

Furthermore, the remote controller 9 is usable to set a lens aperture range, a maximum of gain by the AGC control and a maximum of CCD charging time. Consequently, a predetermined quality of image displayed on the monitor can be maintained.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

What is claimed is:

1. A surveillance camera comprising:
a lens aperture control unit which controls an amount of aperture of a lens so that a predetermined quality of image displayed on a monitor is maintained in taking an image of an object;
an auto gain control unit which controls an image pickup sensitivity;
a filter attachment/detachment control unit which attaches and detaches a color filter for a predetermined wavelength;
a charging time control unit which controls a charging time in charging an image pickup device with electric charge, all the control units being sequentially operated; and
an operation sequence setting unit which sets an operation sequence of the control units according to a type of the object.

2. The surveillance camera according to claim 1, further comprising a threshold setting unit which is capable of setting a threshold for an amount of control executed by the each control unit.
